(19) United States
(12) Patent Application Publication
(10) Pub. No.: US 2005/0171902 A1
(43) Pub. Date: Aug. 4, 2005

(54) Item exchange using a trusted party

(76) Inventor: Martin Khang Nguyen, Westminster, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/095,410

(22) Filed: Mar. 30, 2005

Related U.S. Application Data
(63) Continuation-in-part of application No. 09/931,677, filed on Aug. 15, 2001.

(51) Int. Cl. G06F 17/60

(52) U.S. Cl. 705/39

(57) ABSTRACT

An embodiment of the present invention includes a technique to provide exchange transactions of items from entities. A first item having a value is received from a first entity. The first item is verified and advertised. An exchange agreement between the first item and a second item from a second entity is confirmed. The first and second items are exchanged between the first and second entities.

### BACKGROUND

1. Field of the Invention

Embodiments of the invention relates to the field of marketing products, and more specifically, to item exchange.

2. Description of Related Art

Consumers may be reluctant to buy a specific product or item as a gift for relatives, friends, coworkers, or their loved ones because they may not know the recipient preferences. In addition, it may be time-consuming to shop or select the desirable gift. Companies, stores, and businesses are now increasing using gift cards, gift certificates, or service vouchers as a means to facilitate consumers' gift purchases and at the same time promote products or services. In addition to gift certificates, businesses may also want to market their products or services through other similar mechanisms such as advance purchase certificate, discount coupons, rebates, service or purchase credit certificate, etc. The objective is to allow the consumer to have more flexibility and/or savings on the products or services.

However, there are a number of situations where the above methods may become undesirable, cumbersome, or sometimes inconvenient. For example, a recipient of a gift card from a department store may not want to shop at that department store. A beauty parlor service certificate may become expired too soon.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating an exchange module according to one embodiment of the invention.

FIG. 3 is a diagram illustrating an exchange station according to one embodiment of the invention.

FIG. 4 is a diagram illustrating a processing unit according to one embodiment of the invention.

FIG. 5 is a flowchart illustrating a process to exchange items according to one embodiment of the invention.

FIG. 6 is a diagram illustrating a computer system according to one embodiment of the invention

### RELATED APPLICATIONS

The present application claims priority, as a continuation-in-part (CIP) application, of the following applications: (1) Title: “Discount Purchase Business Method”, filed Aug. 15, 2001, Ser. No. 09/931,677, (2) Title: “Internet Related Discount Coupon Rebate Business Method”, filed Aug. 2, 2002, Ser. No. 10/211,386, (3) Title “Coupon Rebate Business Method Using Portable Personal Communication Devices”, filed Jun. 12, 2003, Ser. No. 10/461,556, (4) Title “Discount Coupon Usage”, filed Sep. 29, 2004, Ser. No. 10/953,009, and (5) Title “On-Line Discount Coupon”, filed Dec. 1, 2004, Ser. No. 11/001,097, the contents of which are hereby incorporated by reference in their entirety.

### DESCRIPTION

An embodiment of the present invention includes a technique to provide exchange transactions of items from entities. A first item having a value is received from a first entity. The first item is verified and advertised. An exchange agreement between the first item and a second item from a second entity is confirmed. The first and second items are exchanged between the first and second entities.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a subprogram, a subroutine, a method of manufacturing or fabrication, etc. When a process corresponds to a function, its termination corresponds to a return of the function to the calling function or the main function.

An embodiment of the invention allows individuals to exchange products, merchandises, gift certificates, etc. A transaction agent or station acts as a broker to verify, authenticate, or determine the value of the items to be exchanged. A transaction center may keep or store the items on behalf of the owners. When there is a match between two items, the transaction agent or station notifies the two parties to forward the items to each other or directly to the agent. Alternatively, if the two parties implicitly consent to the exchange if a match is found and the items are already stored in the transaction center, the transaction agent may notify the parties to pick up the items at the transaction center. The transaction agent or station may also perform other functions related to the items. Examples of these functions include cash dispensing, balance checking, etc.

The transaction agent or station, therefore, acts as a trusted third party in a transaction between two entities. The item issuers (e.g., stores, shops, vendors) provide information on the items to the transaction agent or station so that items can be verified and checked. In this business model, the transaction agent or station acts as a trusted agent for the item issuers and the entities wishing to exchange their items. The business model may follow the model as described in the applications (1) Title: “Discount Purchase Business Method”, filed Aug. 15, 2001, Ser. No. 09/931,677, (2) Title: “Internet Related Discount Coupon Rebate Business Method”, filed Aug. 2, 2002, Ser. No. 10/211,386, (3) Title “Coupon Rebate Business Method Using Portable Personal Communication Devices”, filed Jun. 12, 2003, Ser. No. 10/461,556, (4) Title “Discount Coupon Usage”, filed Sep. 29, 2004, Ser. No. 10/953,009, and (5) Title “On-Line Discount Coupon”, filed Dec. 1, 2004, Ser. No. 11/001,097.

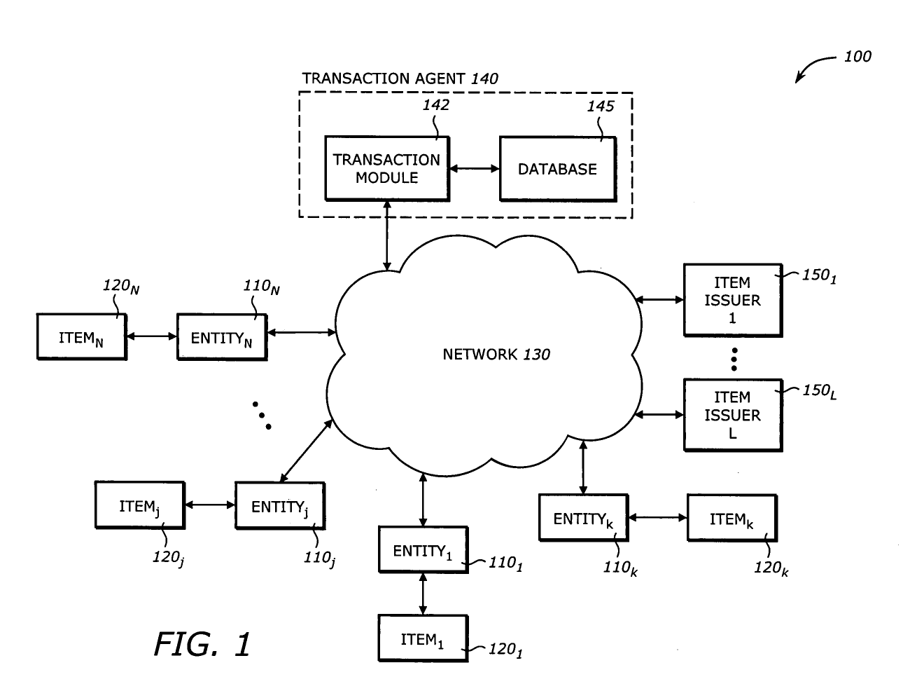

FIG. 1 is a diagram illustrating a system 100 in which one embodiment of the invention can be practiced. The system 100 includes N entities 110₁ to 100_{N} having N items 120₁ to 120_{N}, a network 130, a transaction agent 140, and K item issuers 150₁ to 150_{L}.

Each of the N entities 110₁ to 110_{N} may be an individual, a consumer, an group of individuals or consumers, an organization, a business, a processing system, a transaction system, etc. Each of the N entities 110₁ to 110_{N} has a corresponding item 120ₖ that he or she wants to exchange through the transaction agent 140. Each of the N items 120₁ to 120_{N} may be an item of value such as a membership card, a gift card, a gift certificate, a loyalty program, a reward certificate, a service certificate, a store credit, a credit certificate, a coupon, a discount card, a cash amount, a physical item, a collectible item, or any other items that may be transferable.

The entity 110ₖ logs on to the network 130 through a network interface such as a Web browser to access the transaction agent 140. Typically, the entity 110ₖ has an account with the transaction agent 140 through a registration process. The account may be updated anytime and includes registration information such as personal information of the entity 110ₖ and transactional information. Examples of the registration information may include name, address, phone number(s), e-mail addresses, credit card information, payment method, etc. It is, however, not necessary for the entity 110ₖ to have an account with the transaction agent 140. The transaction may take place at the time the entity 110ₖ is connected to the transaction agent 140. The entity 110ₖ may connect to the network 130 through wired or wireless connectivity such as Bluetooth, Wireless Fidelity (Wi-Fi), hotspot, etc. The wireless connectivity may be via radio frequency (RF), laser, optical medium, ultrasound, or any other communication media. The entity 110ₖ may use any type of interface device to log on the network 130 such as a desktop computer, a notebook, a personal digital assistant (PDA), a cellular device (e.g., cell phone), a remote device, etc.

The network 130 may be any type of network such as a local area network (LAN), a wide area network (WAN), a wireless network, an intranet, an extranet, or the Internet.

The transaction agent 140 represents a business entity that acts as a trusted agent or a middle entity to conduct transactions among the N entities 110₁ to 110_{N} or between the N entities 110₁ to 110_{N} and the L item issuers 150₁ to 150_{L}. In one embodiment, the transaction agent 140 may deal directly with any one of the N entities 110₁ to 110_{N}. In a typical scenario, the transaction agent 140 has a contractual agreement with the L item issuers 150₁ to 150_{L} to represent them to conduct the transactions with the N entities 110₁ to 110_{N}. In another embodiment, the transaction agent 140 may receive information on items issued or sponsored by the L item issuers 150₁ to 150_{L} to verify, authenticate, or validate the items submitted by the N entities 110₁ to 110_{N}. The transaction agent 140 may be implemented as a Web site or link that provides interface to the users.

The transaction agent 140 includes a transaction module 142 and a database 145. The transaction module 142 includes modules to perform the transactions and user interface. The database 145 contains information used by the transaction module 142. The information may include the item information provided by the L item issuers 150₁ to 150_{L}, the registration information of the registered entities, and any other pertinent data.

Each of the L item issuers 150₁ to 150_{L} is the issuer of the N items 120₁ to 120_{N}. The L item issuers 150₁ to 150_{L} may be a vendor, a business, an establishment, an organization, an individual, a financial institution, or any entity that can issue items of value. Examples of the L item issuers 150₁ to 150_{L} may include a bookstore, a bank, a restaurant, a non-profit organization, a university, a professional school, a supermarket, a department store, a boutique, a theme park establishment, a movie studio, a magazine publisher, a movie theater, a concert organizer, an antique store, a furniture store, a professional office (e.g., doctor, lawyer, dentist), an electronics store, a coffee shop, a discount store, a beauty parlor, etc.

The transactions involving the system 100 typically include exchange transactions, redemption transactions, cashing transactions, etc. For example, a person may receive a gift card from a bookstore that allows him to buy the books at some specified amount. That person may not want to use the gift card to buy the books. He or she may decide to exchange the bookstore gift card to another type of gift card or another item of equivalent value or having a value that is accepted by him or her. He or she may also want to sell the gift card to receive cash.

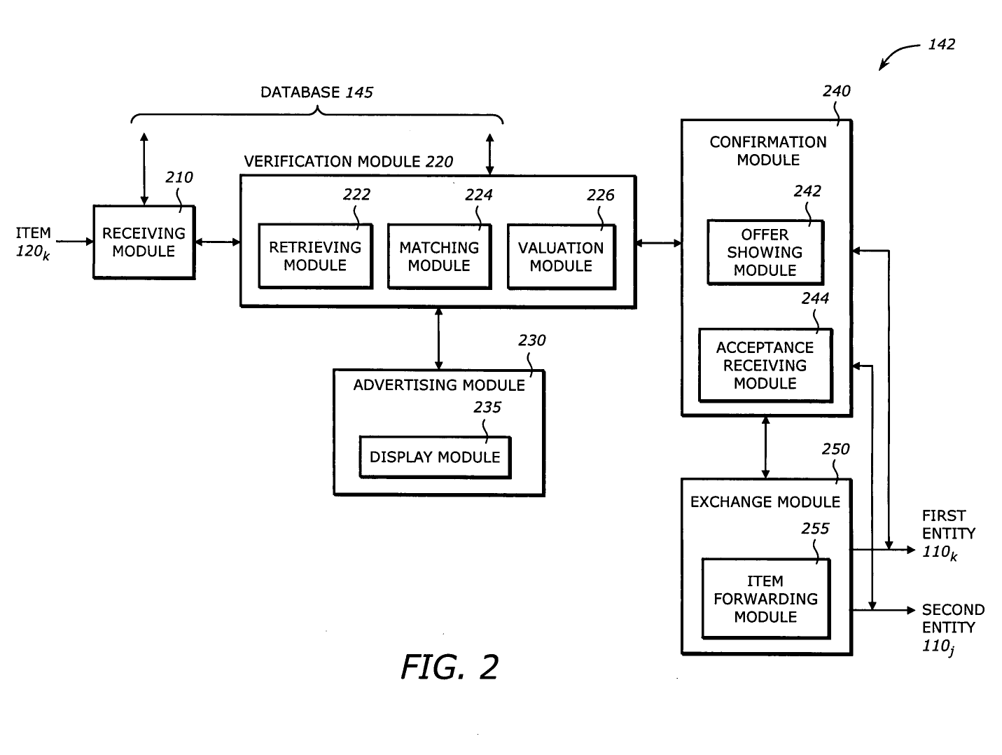

FIG. 2 is a diagram illustrating a transaction module 142 according to one embodiment of the invention. The transaction module 142 includes a receiving module 210, a verification module 220, an advertising module 230, a confirmation module 240, and an item exchange module 250.

The receiving module 210 receives an item 120ₖ having a value from a first entity 110ₖ. The receiving module 210 may receive the item 120ₖ by obtaining item information of the item 120ₖ and obtaining identification information of the item. The item information may include the category of the item 120ₖ, such as gift card, service voucher, cash voucher, discount coupon, rebate, redeemable item, physical item, etc., the expiration date of the item 120ₖ, and any other relevant information about the item 120ₖ. The identification information may include the identifier of the item issuer that issues the item 120ₖ, the identifier of the item 120ₖ, the value of the item 120ₖ, etc. For example, if the item 120ₖ is the service voucher, the item information may include the expiration date. The identification information may include the name or identifier of the service provider (e.g., doctor, dentist), the specific type of service, and the value of the service (e.g., cash equivalent, number of services). The receiving module 210 may then save the item information and the corresponding identification information in the database 145 for later retrieval or merging with other items in the database for advertisement.

The verification module 220 verifies the item 120ₖ. The verification is to ensure that the item 120ₖ is not tampered, void, changed, erased, etc. The verification module 220 verifies the item 120ₖ by retrieving the identification information of the item 120ₖ as obtained from the receiving process, or from the database 145. Then, the verification module 220 matches the identification information with information contained in the database 145. The information may be provided by an item issuer who issues the item 120ₖ. Next, the verification module 220 determines the value of the item 120ₖ. The value may be expressed as a cash equivalent, a service equivalent, or any other suitable metrics. After the item 120ₖ is verified and authenticated, the transaction module 142 may then advertise the item 120ₖ so that other entities may be aware of the availability of the item 120ₖ. The verification module 220 may also check for balance of the item. For example, a pre-purchased card may have been used and the user wants to determine the current balance or the current value. In this scenario, the verification module 220 passes the information to an interface module to display the balance or print out a receipt showing the current value or balance.

The advertising module 230 advertises the item 120ₖ. This can be accomplished by displaying the item, the item information, its identification information, and its value. The item 120ₖ may be displayed together with other items that are offered for exchange in a catalog shown on the Web pages.

The confirmation module 240 confirms an exchange agreement between the item 120ₖ and another item from an entity 110ⱼ. The entity 110ⱼ may have submitted the item 120ⱼ through the same process as the entity 110ₖ or through other process such as prior registration. There are a number of ways that the exchange agreement may be confirmed. In one method, the confirmation module 240 requests the entity 110ₖ to complete an offer statement to offer the item under specified conditions. The specified conditions may include the type of items the entity 110ₖ wishes to exchange and its value. For example, the entity 110ₖ may want to exchange the item 120ₖ for a gift certificate for facial massage or a restaurant meal for two at an equivalent value of $50. Upon receipt of this offer statement, the confirmation module 240 searches for any items that are available and satisfy the conditions. If such item or items are found, the confirmation module 240 goes through the items listed in the database, and search for those having a matching requirements or conditions. If there are no matches, the confirmation module 240 indicates to the entity 110ₖ that no matches are found. The confirmation module 240 may then save the offer statement to show to other entities. If there is a match, the confirmation module 240 informs the entity 110ₖ. The entity 110ₖ may then send an offer acceptance to the transaction agent 140. In some scenarios, the entity 110ₖ does not need to explicitly accept the offer from the entity 110ₖ. The acceptance may be implicit in the offer statement. In other words, the entity 110ₖ would accept any item listed in the catalog that satisfies his own requirements. Upon receipt of the acceptance statement, either explicitly or implicitly, the confirmation module 240 proceeds to exchange the items using the exchange module 250.

The exchange module 250 exchanges the items 120ₖ and between the entities 110ₖ and 110ⱼ. The exchange module 250 forwards item 120ⱼ to the entity 120ₖ and the item 120ₖ to the entity 110ₖ. The exchange module 250 may instruct the entities 110ₖ and 110ⱼ to send the items to the transaction agent 140 or to send the items directly to each other depending on the conditions and terms agreed upon in the offer statements.

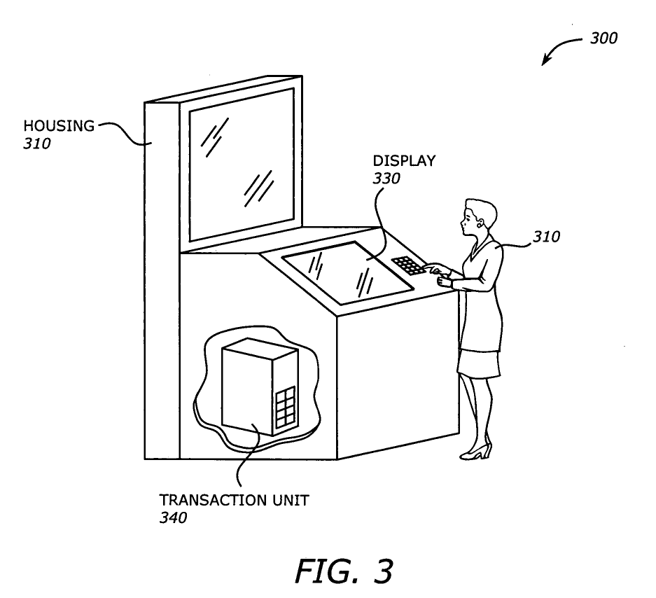

FIG. 3 is a diagram illustrating a transaction station system 300 according to one embodiment of the invention. The transaction station system 300 may take place at a public place (e.g., shopping mall, supermarket, hotel, campus) or a designated place. The transaction station system operates in a similar manner as the system 100 shown in FIG. 1 except that the transaction may be conducted with a station rather than through the Web. It includes a user 310, housing 320, a user interface 330, and a transaction unit 340.

The user 310 is an entity having an item to be transacted. The item may be any one of a transferable item such as a gift card, a service voucher, a discount coupon, etc., as discussed above. The user 310 is typically an individual, a consumer, a business representative representing a business entity, or any other entity that wishes to carry out a transaction with a standalone station.

The housing 320 provides housing or enclosure for the transaction unit 340 and the user interface 330. It may be constructed like a kiosk or a transaction machine (e.g., automated teller machine). It is typically located at a strategic location in public to facilitate access and increase safety.

The user interface 330 includes output device(s) and user input entry device(s). The output devices may include voice activated unit, speaker, cash dispenser, item dispenser, printer, etc. The display panel may be a cathode ray tube (CRT) display, a flat panel display, a touch screen, or any other suitable display. The user input entry device may include keyboard, buttons, mouse, card reader, etc.

The transaction unit 340 includes modules to perform the local and remote transactions. It has interfacing modules to control the user interface 330. It may include interface to a network that allows the information to be exchanged with a remote transaction center. The transaction unit 340 includes a database that contains information about the items. The information may be provided by the associated item issuers.

In a typical scenario, the user 310 carries the item to be transacted. For example, the user 310 may want to exchange a gift card. The gift card contains the identification information such as the identifier of the card issuer, the item type, and the value of the card. The user 310 enters selection on the user interface 330 such as pressing buttons to select the type of transaction. After selecting the transaction, the user 310 slides the gift card through a card reader. The card reader reads the item identification information embedded in the magnetic strip. If the identification information is not recognized by the transaction unit 340, the display indicates that fact to the user 310. If the card is honored by the station, i.e., the database in the transaction unit 340 indicates that it is a valid card and the card has not expired, the transaction unit 340 verifies the card and inquires an offer statement from the user 310. For example, the user 310 may want to exchange the card for another item of comparable amount. The transaction unit 340 then displays or advertises all the items in the database that are available for exchange. The user 310 may browse through the catalog of these items and select the desirable item. When there are multiple items that meet the requirements of the user 310, the user 310 may select the items according to some priority or preference order. By selecting the item or items, the user 310 effectively provides an acceptance of the offer by entities who offer these items.

If the user 310 does not find any item of interest, he or she may still want to leave his or her item for advertisement. The user 310 therefore provides an offer statement which states his or her preferences of the item or items to be exchanged with his or her item. The offer statement may include the type of the item, the item's specific description, the item value, and the type or types of other items that the user 310 wishes to exchange. An acceptance of an offer from any other entity who has an item that satisfies the preferences or conditions may be implicit or explicit. In addition, the transaction station may contain cash and a cash dispenser to return cash to the user 310 if the user 310 wants to sell the item. In another embodiment, the transaction station may issue a receipt containing the value of the item so that the user 310 may bring it to an exchange center to exchange for other merchandise, items, or even cash.

The user 310 may leave his or her item at the transaction station or a transaction center that is authorized to act on behalf of the transaction agent. In this case, the transaction center acts as a broker to have custody of the items so that an exchange can be made once the offer acceptances are confirmed. The user 310 may also want to keep the item and will forward the item to another entity upon notification that a matching offer has been found.

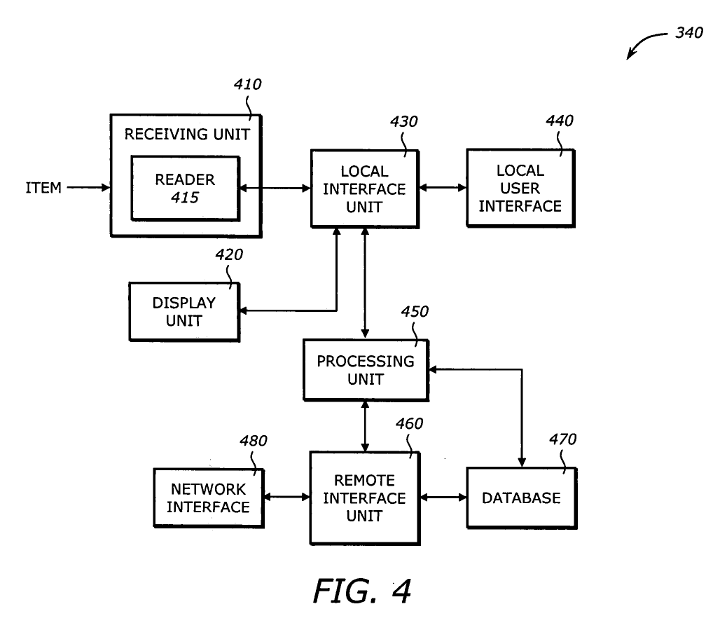

FIG. 4 is a diagram illustrating a transaction unit 340 according to one embodiment of the invention. The transaction unit 340 includes a receiving unit 410, a display unit 420, a local interface unit 430, a local user interface 440, a processing unit 450, a remote interface unit 460, a database 470, and a network interface 480.

The receiving unit 420 obtains the item information and the identification information of the item. It may include a reader 415 to read the item information and/or identification information from the item. The reader 415 may be a magnetic card reader, a bar code reader, a radio frequency identification (RFID) reader, or any device that can read and decode the information embedded in the item.

The display unit 420 advertises the item by displaying the item, its description, identification and its value on the display 330. The display unit 420 may organize the items according to categories, types, or values. The display unit 420 allows the user to browse through for selection of desirable items, products, or merchandises.

The local interface unit 430 shows a second offer statement for the second item provided by the second entity to the first entity. The local interface unit 430 receives a second acceptance statement for the second item from the first entity. When the exchange begins, the local interface unit 430 may forward the second item to the first entity. The forwarding may take place by a notification to the second entity to request the second entity to send the second item to the first entity according to the shipping method specified or agreed by the first entity.

The local user interface unit 440 provides user interface at the transaction station. This may include interfacing to input entry devices such as keyboard, buttons, touch screen, mouse, joystick, trackball, or output devices such as display, speaker, cash dispenser, item dispenser, printer, etc.

The processing unit 450 retrieves the identification information of the first item from the entry or from the database 470. It then matches the identification information with the database 470. The information contained in the database 470 may be provided by the item issuer issuing the first item. From this information, the processing unit 450 determines the value of the first item.

The remote interface unit 460 shows a first offer statement for the first item provided by the first entity to the second entity. The remote interface unit 460 receives an acceptance statement for the first item from the second entity. When the exchange begins, the remote interface unit 460 may forward the first item to the second entity. The forwarding may take place by a notification to the first entity to request the first entity to send the first item to the second entity according to the shipping method specified or agreed by the second entity.

The database 470 is a storage that stores information on items issued by the item issuers. The information may include the description of the items, associated values, the expiration, and the exchange preferences, etc. The information may be updated periodically to reflect the current items.

The network interface 480 provides interface to a network to receive or transmit information from or to a remote center. The network interface 480 may include interface to receive information transmitted by the user or to transmit the information through wired or wireless connectivity.

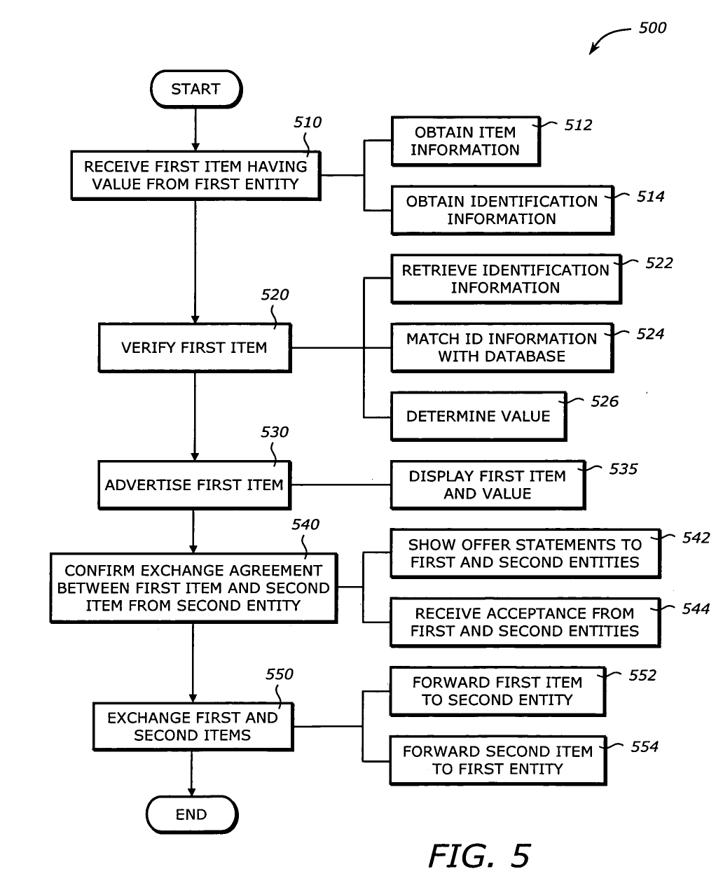

FIG. 5 is a flowchart illustrating a process 500 to transact items according to one embodiment of the invention.

Upon START, the process 500 receives a first item having a value from a first entity (Block 510). This may be performed by obtaining the item information (Block 512) and obtaining the identification information of the item (Block 514). Next, the process 500 verifies the first item (Block 520). This may be performed by retrieving the identification information from a database (Block 522) or as obtained from the receiving operation, matching the identification information with information contained from the database provided by the item issuer (Block 524), and determining the value of the item (Block 526).

Next, the process 500 advertises the first item (Block 530). This can be performed by displaying the first item and its value (Block 535). The display may be made as part of a catalog display or as selected by interested entities. Then, the process 500 confirms an exchange agreement between the first item and a second item from a second entity (Block 540). This may be performed by showing an offer statement from the first entity to the second entity and a second offer statement from the second entity to the first entity (Block 542), and receiving a first acceptance statement from the first entity and a second acceptance statement from the second entity (Block 544).

Next, the process 500 exchanges the first and second items. This can be performed by forwarding the first item to the second entity (Block 552) and forwarding the second item to the first entity (Block 554). The exact method of forwarding depends on the specific instructions in the corresponding offer statements. Then, the process 500 is terminated.

Elements of one embodiment of the invention may be implemented by hardware, firmware, software or any combination thereof. When implemented in software, the elements of an embodiment of the present invention are essentially the code segments to perform the necessary tasks. The software may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described above. The term “data” here refers to any type of information that is encoded for machine-readable purposes. Therefore, it may include program, code, data, file, etc.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

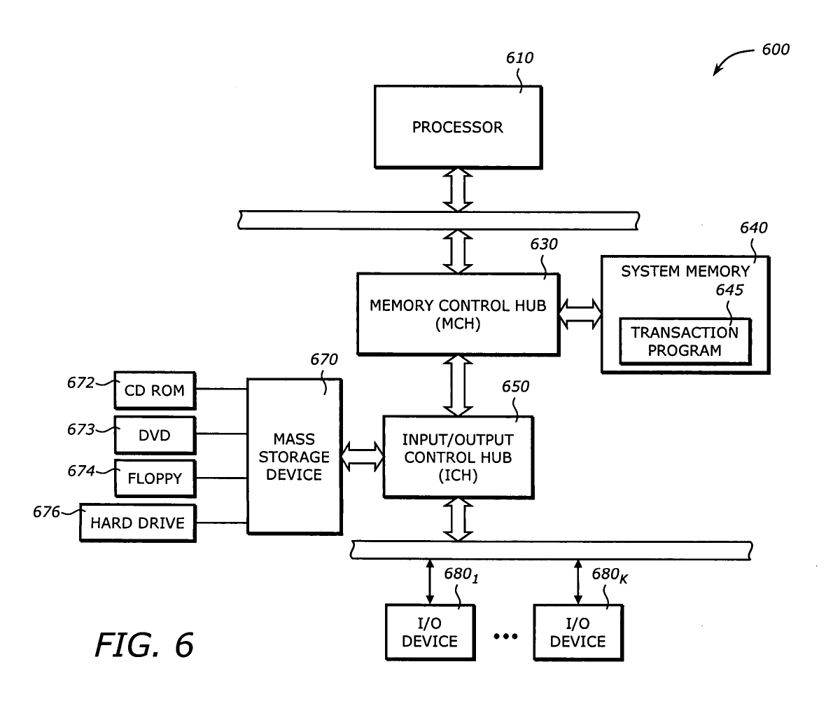

FIG. 6 is a diagram illustrating a computer system 600 according to one embodiment of the invention. The system 600 may be a server that connects to the network to implement the functionalities of the transaction agent or module or the transaction station shown in FIGS. 1 and 3. It includes a host processor 610, a memory control hub (MCH) 630, a system memory 640, an input/output control hub (ICH) 650, a mass storage device 670, and input/output devices 680₁ to 680_{K}. Note that the system 600 may include more or less elements than these elements.

The host processor 610 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MCH 630 provides control and configuration of memory and input/output devices such as the system memory 640 and the ICH 650. The MCH 630 may be integrated into a chipset that integrates multiple functionalities such as the isolated execution mode, host-to-peripheral bus interface, memory control. The MCH 630 interfaces to a peripheral bus. For clarity, not all the peripheral buses are shown. It is contemplated that the system 600 may also include peripheral buses such as Peripheral Component Interconnect (PCI), accelerated graphics port (AGP), Industry Standard Architecture (ISA) bus, and Universal Serial Bus (USB), etc.

The system memory 640 stores system code and data. The system memory 640 is typically implemented with dynamic random access memory (DRAM) or static random access memory (SRAM). The system memory may include program code or code segments implementing one embodiment of the invention. The system memory includes the transaction program 645 that implements the functionalities of the transaction agent 140 (FIG. 1) or the transaction unit 340 (FIG. 3). Any one of the elements of the transaction program 645 may be implemented by hardware, software, firmware, microcode, or any combination thereof. The system memory 640 may also include other programs or data which are not shown, such as an operating system.

The ICH 650 has a number of functionalities that are designed to support I/O functions. The ICH 650 may also be integrated into a chipset together or separate from the MCH 630 to perform I/O functions. The ICH 650 may include a number of interface and I/O functions such as PCI bus interface, processor interface, interrupt controller, direct memory access (DMA) controller, power management logic, timer, system management bus (SMBus), universal serial bus (USB) interface, mass storage interface, low pin count (LPC) interface, etc.

The mass storage device 670 stores archive information such as code, programs, files, data, applications, and operating systems. The mass storage device 670 may include compact disk (CD) ROM 672, a digital video/versatile disc (DVD) 673, floppy drive 674, and hard drive 676, and any other magnetic or optic storage devices. The mass storage device 670 provides a mechanism to read machine-accessible media. The machine-accessible media may contain computer readable program code to perform tasks as described above.

The I/O devices 680₁ to 680_{K} may include any I/O devices to perform I/O functions. Examples of I/O devices 680₁ to 680_{K} include controller for input devices (e.g., keyboard, mouse, trackball, pointing device), media card (e.g., audio, video, graphics), network card, and any other peripheral controllers.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
receiving a first item having a value from a first entity;
verifying the first item;
advertising the first item;
confirming an exchange agreement between the first item and a second item from a second entity; and
exchanging the first and second items between the first and second entities.

2. The method of claim 1 wherein receiving comprises:
obtaining item information of the first item; and
obtaining identification information of the first item.

3. The method of claim 2 wherein obtaining the identification information comprises:
reading the identification information by a reader.

4. The method of claim 2 wherein verifying comprises:
retrieving the identification information of the first item;
matching the identification information with a database provided by an item issuer issuing the first item; and
determining the value of the first item.

5. The method of claim 4 wherein advertising comprises:
displaying the first item; and
displaying the value of the first item.

6. The method of claim 1 wherein confirming the exchange agreement comprises:
showing a first offer statement for the first item provided by the first entity to the second entity;
receiving an acceptance statement for the first item from the second entity;
showing a second offer statement for the second item provided by the second entity to the first entity;
receiving a second acceptance statement for the second item from the first entity.

7. The method of claim 1 wherein exchanging comprises:
forwarding the first item to the second entity; and
forwarding the second item to the first entity.

8. The method of claim 3 wherein reading the identification information comprises:
reading the identification information by the reader at a transaction station.

9. The method of claim 1 wherein receiving the first item comprises:
receiving the first item being one of a membership card, a gift card, a gift certificate, a loyalty program, a reward certificate, a service certificate, a store credit, a credit certificate, a coupon, a discount card, a cash amount, a physical item, a collectible item, and a transferable item.

10. The method of claim 1 wherein confirming comprises:
confirming the exchange agreement between the first item and a second item, the second item being one of a membership card, a gift card, a gift certificate, a loyalty program, a reward certificate, a service certificate, a store credit, a credit certificate, a coupon, a discount card, a cash amount, a physical item, a collectible item, and a transferable item.

11. An apparatus comprising:
a receiving unit to receive a first item having a value from a first entity;
a processing unit coupled to the receiver to verify the first item; and
a display unit coupled to the processing unit to advertise the first item;
wherein the processing unit confirms an exchange agreement between the first item and a second item from a second entity and exchanges the first and second items between the first and second entities.

12. The apparatus of claim 11 wherein the receiving unit obtains item information and identification of the first item.

13. The apparatus of claim 12 wherein the receiving unit comprises:
a reader to read at least one of item information and identification information of the first item.

14. The apparatus of claim 12 wherein the processing unit retrieves the identification information of the first item, matches the identification information with a database provided by a vendor issuing the first item, and determines the value of the first item.

15. The apparatus of claim 14 wherein the display unit displays the first item and the value of the first item.

16. The apparatus of claim 11 wherein the processing unit comprises:
a remote interface unit to show a first offer statement for the first item provided by the first entity to the second entity, the remote interface unit receiving an acceptance statement for the first item from the second entity;
a local interface unit to show a second offer statement for the second item provided by the second entity to the first entity, the local interface unit receiving a second acceptance statement for the second item from the first entity.

17. The apparatus of claim 11 wherein the remote interface unit forwards the first item to the second entity, and the local interface unit forwards the second item to the first entity.

18. The apparatus of claim 13 wherein the reader is located at a transaction station.

19. The apparatus of claim 11 wherein one of the first item and the second item is one of a membership card, a gift card, a gift certificate, a loyalty program, a reward certificate, a service certificate, a store credit, a credit certificate, a coupon, a discount card, a cash amount, a physical item, a collectible item, and a transferable item.

20. An article of manufacture comprising:
a machine-accessible medium including data that, when accessed by a machine, causes the machine to perform operations comprising:
receiving a first item having a value from a first entity;
verifying the first item;
advertising the first item;
confirming an exchange agreement between the first item and a second item from a second entity; and
exchanging the first and second items between the first and second entities.

21. The article of manufacture of claim 20 wherein the data causing the machine to perform receiving comprises data that, when accessed by the machine, causes the machine to perform operations comprising:
obtaining item information of the first item; and
obtaining identification information of the first item.

22. The article of manufacture of claim 21 wherein the data causing the machine to perform obtaining the identification information comprises data that, when accessed by the machine, causes the machine to perform operations comprising:
reading the identification information by a reader.

23. The article of manufacture of claim 21 wherein the data causing the machine to perform verifying comprises data that, when accessed by the machine, causes the machine to perform operations comprising:
retrieving the identification information of the first item;
matching the identification information with a database provided by an item issuer issuing the first item; and
determining the value of the first item.

24. The article of manufacture of claim 23 wherein the data causing the machine to perform advertising comprises data that, when accessed by the machine, causes the machine to perform operations comprising:
displaying the first item; and
displaying the value of the first item.

25. The article of manufacture of claim 20 wherein the data causing the machine to perform confirming the exchange agreement comprises data that, when accessed by the machine, causes the machine to perform operations comprising:
showing a first offer statement for the first item provided by the first entity to the second entity;
receiving an acceptance statement for the first item from the second entity;
showing a second offer statement for the second item provided by the second entity to the first entity;
receiving a second acceptance statement for the second item from the first entity.

26. The article of manufacture of claim 20 wherein the data causing the machine to perform exchanging comprises data that, when accessed by the machine, causes the machine to perform operations comprising:
forwarding the first item to the second entity; and
forwarding the second item to the first entity.

27. The article of manufacture of claim 22 wherein the data causing the machine to perform reading the identification information comprises data that, when accessed by the machine, causes the machine to perform operations comprising:
reading the identification information by the reader at an exchange station.

28. The article of manufacture of claim 21 wherein one of the first item and the second item is one of a membership card, a gift card, a gift certificate, a loyalty program, a reward certificate, a service certificate, a store credit, a credit certificate, a coupon, a discount card, a cash amount, a physical item, a collectible item, and a transferable item.

29. A system comprising:
a first entity having a first item having a value; and
a transaction agent coupled to first entity via a network, the transaction agent having an transaction module, the transaction module comprising:
a receiving module to receive a first item from the first entity,
a verification module coupled to the receiving module to verify the first item,
an advertising module to advertise the first item,
a confirmation module to confirm an exchange agreement between the first
item and a second item from a second entity, and
an exchange module to exchange the first and second items between the first and second entities.

30. The system of claim 29 wherein one of the first item and the second item is one of a membership card, a gift card, a gift certificate, a loyalty program, a reward certificate, a service certificate, a store credit, a credit certificate, a coupon, a discount card, a cash amount, a physical item, a collectible item, and a transferable item.
